(19) United States
(12) Patent Application Publication
(10) Pub. No.: US 2015/0143493 A1
(43) Pub. Date: May 21, 2015

(54) ELECTRONIC DEVICE AND LOGIN METHOD THEREOF

(71) Applicant: QNAP SYSTEMS, INC., New Taipei City (TW)

(72) Inventors: Feng-Hsu Tsai, New Taipei City (TW); Chung-Li Lin, New Taipei City (TW); Chia-Ying Chuang, New Taipei City (TW)

(73) Assignee: QNAP SYSTEMS, INC., New Taipei City (TW)

(21) Appl. No.: 14/218,994

(22) Filed: Mar. 19, 2014

(30) Foreign Application Priority Data
Nov. 21, 2013 (TW) 102142497

(51) Int. Cl. H04L 29/06

(52) U.S. Cl. CPC H04L 63/083
USPC 726/7

(57) ABSTRACT

An electronic device and a login method thereof are provided. The method includes the following steps. A first user information is received. A login authentication message corresponding to the first user information is obtained according to the first user information. A current sequence combination corresponding to a plurality of function buttons being pressed is received, and the function buttons are used for controlling the electronic device to execute a plurality of functions correspondingly. The current sequence combination is compared with a preset sequence combination of function buttons in the login authentication message. Whether a login process of the first user information is completed is determined. Accordingly, difficulties in entering a password may be solved by the function buttons on a remote controller, and an identity authentication may be simplified and quickly completed, so as to provide a better user experience for the user.

### CROSS-REFERENCE TO RELATED APPLICATION

This application claims the priority benefit of Taiwan application serial no. 102142497, filed on Nov. 21, 2013. The entirety of the above-mentioned patent application is hereby incorporated by reference herein and made a part of this specification.

### BACKGROUND OF THE INVENTION

1. Field of the Invention

The invention relates to an electronic device and a login method thereof, and more particularly, to an electronic device and a login method thereof, capable of easily entering password by utilizing function buttons.

2. Description of Related Art

When a user utilizes an electronic product to login an encrypted interface or system, an account and a password are usually entered for an identity authentication. Therein, the password is usually a character assembly of English characters or numbers.

In case the user utilizes a computer for a login operation, the user may directly enter said character assembly of English characters or numbers through English characters buttons and/or number buttons on a keyboard, so as to complete the identity authentication for logging in the system. However, for another circumstance in which the user utilizes a television interface for login, since buttons corresponding to the character assembly of English characters or numbers may not be provided by a television equipment, the user may only utilize a direction button of a remote controller to control a cursor to move frame by frame, so as to select each of virtual buttons in a virtual keyboard displayed on a screen corresponding to English characters or numbers for entering the password. Above-said operation leads to difficulties in process of the identity authentication, and the user may not be able to intuitively enter the password. Accordingly, it is necessary to provide a login method which is more convenient, so as to solve the difficulties in entering the password through the television interface for the user.

### SUMMARY OF THE INVENTION

The invention is directed to an electronic device and a login method, capable of quickly completing and simplifying the identity authentication, solving the difficulties in entering the password, so as to provide a better user experience for the user.

The invention provides a login method of an electronic device. The login method of the electronic device of the invention includes the following steps: receiving a first user information; obtaining a login authentication message corresponding to the first user information according to the first user information; receiving a current sequence combination corresponding to a plurality of function buttons being pressed, and the function buttons are used for controlling the electronic device to execute a plurality of functions correspondingly; comparing the current sequence combination with a preset sequence combination of function buttons in the login authentication message; and determining whether a login process of the first user information is completed.

In an embodiment of the invention, the step of obtaining the login authentication message corresponding to the first user information according to the first user information includes: determining whether a login authentication process corresponding to the first user information is completed according to the first user information, thereby obtaining the login authentication message corresponding to the first user information.

In an embodiment of the invention, the login authentication message is corresponding to a valid time, and the step of determining whether the login authentication process corresponding to the first user information is completed, thereby obtaining the login authentication message corresponding to the first user information includes: executing the login authentication process for the first user information when the login authentication process corresponding to the first user information is not completed, thereby obtaining the login authentication message corresponding to the first user information; and determining whether the login authentication message is valid according to a login time information of the first user information and the valid time when the login authentication process corresponding to the first user information is completed, thereby obtaining the login authentication message corresponding to the first user information.

In an embodiment of the invention, the step of executing the login authentication process for the first user information when the login authentication process corresponding to the first user information is not completed, thereby obtaining the login authentication message corresponding to the first user information includes: receiving an input password; comparing the input password with a first user password corresponding the first user information, thereby determining whether the input password is identical to the first user password; and completing the login authentication process corresponding to the first user information and obtaining the login authentication message when the input password is identical to the first user password.

In an embodiment of the invention, the function buttons are physical function buttons. After the login authentication message is obtained, the login method includes: setting the preset sequence combination of physical function buttons in the login authentication message.

In an embodiment of the invention, the step of setting the preset sequence combination of function buttons in the login authentication message includes: receiving an input sequence combination of function buttons; receiving a confirmation operation for determining whether the confirmation operation is identical to the input sequence combination of function buttons; and setting the input sequence combination of function buttons as the preset sequence combination of function buttons in the login authentication message when the confirmation operation is identical to the input sequence combination of function buttons.

In an embodiment of the invention, the step of determining whether the login authentication message is valid when the login authentication process corresponding to the first user information is completed includes: re-executing the login authentication process for the first user information when the login authentication message is invalid, thereby obtaining the login authentication message and setting the preset sequence combination of function buttons.

The invention provides an electronic device. The electronic device of the invention includes a receiving unit and a processing unit. The receiving unit receives a first user information and a current sequence combination corresponding to a plurality of function buttons being pressed, and the function buttons are used for controlling the electronic device to execute a plurality of functions correspondingly. The processing unit is coupled to the receiving unit. The processing unit obtains a login authentication message corresponding to the first user information according to the first user information, and compares the current sequence combination with a preset sequence combination of function buttons in the login authentication message, thereby determining whether a login process of the first user information is completed.

In an embodiment of the invention, the processing unit determines whether a login authentication process corresponding to the first user information is completed according to the first user information, thereby obtaining the login authentication message corresponding to the first user information.

In an embodiment of the invention, the login authentication message is corresponding to a valid time. The processing unit executes the login authentication process for the first user information when the login authentication process corresponding to the first user information is not completed, thereby obtaining the login authentication message corresponding to the first user information. The processing unit determines whether the login authentication message is valid according to a login time information of the first user information and the valid time when the login authentication process corresponding to the first user information is completed, thereby obtaining the login authentication message corresponding to the first user information.

In an embodiment of the invention, when the login authentication process corresponding to the first user information is not completed, the receiving unit receives an input password. The processing unit compares the input password with a first user password corresponding the first user information, thereby determining whether the input password is identical to the first user password. The processing unit completes the login authentication process corresponding to the first user information and obtains the login authentication message when the input password is identical to the first user password.

In an embodiment of the invention, after the login authentication message is obtained, the processing unit sets the preset sequence combination of function buttons in the login authentication message.

In an embodiment of the invention, the receiving unit receives an input sequence combination of function buttons and a confirmation operation. The processing unit determines whether the confirmation operation is identical to the input sequence combination of function buttons. The processing unit sets the input sequence combination of function buttons as the preset sequence combination of function buttons in the login authentication message when the confirmation operation is identical to the input sequence combination of function buttons.

In an embodiment of the invention, when the login authentication process corresponding to the first user information is completed and the processing unit determines that the login authentication message is invalid, the electronic device re-executes the login authentication process for the first user information, thereby obtaining the login authentication message and setting the preset sequence combination of function buttons.

In an embodiment of the invention, the electronic device comprises a display device, and the function buttons are virtual function buttons displayed on the display device. The receiving unit receives the current sequence combination corresponding to the function buttons being pressed through the virtual function buttons.

In an embodiment of the invention, the virtual function buttons comprise at least one of a direction button, a volume control button, a channel selection button, a page selection button, a menu button and a mute button.

In an embodiment of the invention, the receiving unit receives the current sequence combination corresponding to the virtual function buttons being pressed through a remote-control device having the virtual function buttons or a wireless electronic device having the virtual function buttons, such as a smartphone or a tablet pc.

In an embodiment of the invention, the function buttons include at least one of a physical direction button, a physical volume control button, a physical channel selection button, a physical page selection button, a physical menu button and a physical mute button.

In an embodiment of the invention, the receiving unit receives the current sequence combination corresponding to function buttons being pressed through a remote-control device having the function buttons.

In an embodiment of the invention, the electronic device is further connected to a cloud server through a network, and the server includes a user database that provides a plurality of user information to the receiving unit through the network.

Based on above, when the identity authentication of the user is performed, the electronic device and the login method thereof according to the embodiments of the invention are capable of obtaining the login authentication message corresponding to the user and the sequence combination of function buttons thereof to be used as the passcode for authentication of the user to facilitate in login. Accordingly, difficulties in entering a password may be solved by the function buttons on a remote controller, and an identity authentication may be simplified and quickly completed, so as to provide a better user experience for the user.

To make the above features and advantages of the disclosure more comprehensible, several embodiments accompanied with drawings are described in detail as follows.

### BRIEF DESCRIPTION OF THE DRAWINGS

FIG. 1 is a block diagram illustrating an electronic device according to an embodiment of the invention.

FIG. 2 is an example illustrating function buttons according to an embodiment of the invention.

FIG. 3 is a flowchart illustrating a login method according to an embodiment of the invention.

FIG. 4 is a flowchart illustrating a login method according to an embodiment of the invention.

FIG. 5 is an example illustrating a login method according to an embodiment of the invention.

FIG. 6 is a flowchart illustrating a login authentication process according to an embodiment of the invention.

FIG. 7 is an example illustrating a login method according to an embodiment of the invention.

FIG. 8 is a flowchart illustrating setting of a preset sequence combination of function buttons according to an embodiment of the invention.

FIG. 9 is an example illustrating a set passcode according to an embodiment of the invention.

FIG. 10 is an example illustrating a set passcode according to an embodiment of the invention.

FIG. 11 is an example illustrating a login method according to an embodiment of the invention.

### DESCRIPTION OF THE EMBODIMENTS

The user may operate the television interface to connect to a Network Attached Storage (NAS) server through a network. However, the user intending to log in the system is request to enter the password, since the password is usually the character assembly of English characters or numbers, and in case physical buttons corresponding to the character assembly of English characters or numbers are not provided by the television equipment, the user may only utilize the direction button of the remote controller to control the cursor to move frame by frame, so as to select the virtual buttons in the virtual keyboard displayed on the screen representing English characters or numbers for entering the password. An operating experience of the user may be significantly influenced by such complex identity authentication and the difficulties in entering the password. Accordingly, the electronic device and the login method according to the embodiments of the invention are capable of setting a sequence combination of pressed function buttons corresponding to said login authentication message through a plurality of function buttons on the remote controller or other devices after the identity authentication is completed by the user and a login authentication message is obtained, so that the sequence combination may serve as a passcode of the identity authentication of the user for facilitating in logging in the system. Therefore, by using the passcode composed of the function buttons according to the embodiments of the invention, the difficulties in entering the password may be solved, and the identity authentication may be simplified and quickly completed, so as to provide a better user experience for the user.

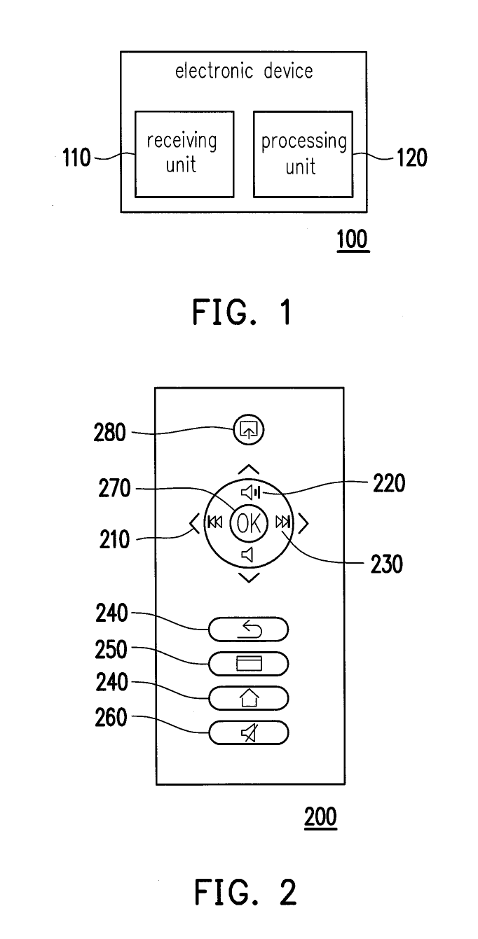

FIG. 1 is a block diagram illustrating an electronic device according to an embodiment of the invention. Referring to FIG. 1, an electronic device 100 includes a receiving unit 110 and a processing unit 120. Therein, the processing unit 120 is coupled to the receiving unit 110. The electronic device 100 may be a Network Attached Storage (NAS) server that uses the network as an expansion for storage spaces. Therein, Network Attached Storage (NAS) refers to a data storing technology capable of directly connecting to a computer network, providing a centralized data access service for users in a heterogeneous network, and serially connecting electronic devices (e.g., a computer, a television or a game console) together for sharing files to one another. In other embodiments, the electronic device 100 of the present embodiment of the invention may be any electronic device as long as such electronic device requires the user to enter authentication information (e.g., the account and the password) for the identity authentication before the user can log in the system.

The receiving unit 110 receives a first user information and a current sequence combination corresponding to a plurality of function buttons being pressed, and the function buttons are used for controlling the electronic device 100 to execute a plurality of functions correspondingly. In the present embodiment, the electronic device 100 may further comprises a display device such as a Liquid-Crystal Display (LCD) display or a Light-Emitting Diode (LED) display through the network, and the receiving unit 110 may receive an input operation of the user by utilizing a user login screen displayed on the display device. Herein, the network may be realized in a manner of wired or wireless communication methods, and the invention is not limited thereto.

On the other hand, in an embodiment, the electronic device 100 may include said function buttons. Therefore, the receiving unit 110 may be directly coupled to the function buttons, so as to obtain the sequence combination of function buttons being pressed according to a sequence of function buttons pressed by the user. In another embodiment, the user may also use a remote control device (e.g., the remote controller) for controlling the electronic device 100 to operate the function buttons on the remote control device, so that the receiving unit 110 may utilize a wireless signal broadcasting technology (e.g., infrared signals) to obtain a sequence combination of the physical function buttons pressed by the user. The physical function buttons may include at least one of a physical direction button, a physical volume control button, a physical channel selection button, a physical page selection button, a physical menu button and a physical mute button, which are respectively used for controlling various functions of the electronic device. Further, in other embodiments, the receiving unit 110 may also receive signals sent from applications installed by the user in a mobile device (e.g., a smart phone or a tablet computer), or sent by the user through the function buttons on the mobile device, so as to obtain the sequence combination of function buttons being pressed. The function buttons may be virtual function buttons displayed on the display device, or the virtual function button may be displayed on the display device of the remote-control device, or the virtual function button may be displayed on wireless electronic device having the virtual function buttons, such as a smartphone or a tablet pc. The receiving unit 110 may receive the current sequence combination corresponding to the function buttons being pressed through the virtual function buttons. In other embodiment of the disclosure, the receiving unit 110 may receive the current sequence combination corresponding to the virtual function buttons being pressed through the remote-control device having the virtual function buttons. The virtual function buttons may be a combination of a direction button, a volume control button, a channel selection button, a page selection button, a menu button and a mute button. Person skilled in the art may have different implementations for the function buttons based on the actual demands, and the invention is not limited thereto.

FIG. 2 is an example illustrating function buttons according to an embodiment of the invention. In the present embodiment, a remote control device 200 is used for illustration for instance. As shown in FIG. 2, the remote control device 200 of the present embodiment may include the physical function buttons such as a direction button 210, a volume control button 220, a channel selection button 230, a page selection button 240 (which may include a return button and a home button), a menu button 250 and a mute button 260. The electronic device 100 may receive operations of the user through the physical function buttons on the remote control device 200 for controlling the electronic device 100 to execute each function corresponding to the physical function buttons. Furthermore, in the present embodiment, the sequence combination of the physical function buttons pressed by the user may be used as a passcode for the identity authentication when logging in the system. Moreover, the remote control device 200 further includes a confirm button 270 for sending a signal identifying that the input operation is completed. Namely, it indicates that the input operation is completed by the user when the sequence combination of the physical buttons is entered and the confirm button is pressed by the user. In addition, a power button 280 of the remote control device 220 may be used to turn on/off the electronic device 100.

The processing unit 120 is, for example, a central processing unit (CPU) or other programmable devices for general purpose or special purpose such as a microprocessor and a digital signal processor (DSP), a programmable controller, an application specific integrated circuit (ASIC), a programmable logic device (PLD) or other similar devices or a combination of above-mentioned devices.

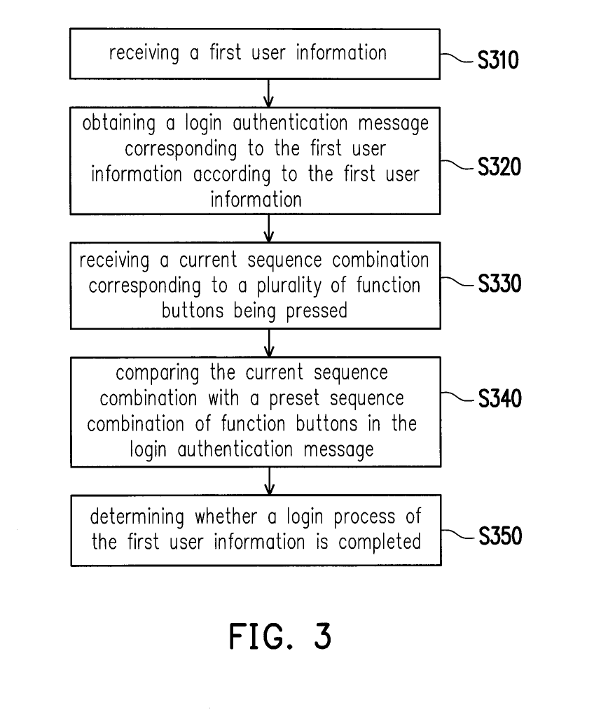

FIG. 3 is a flowchart illustrating a login method according to an embodiment of the invention. Referring to FIG. 1 and FIG. 3 together, a method of the present embodiment is suitable for the electronic device 100. Detailed steps in the method of the present embodiment are described as below, with reference to each element of the electronic device 100 depicted in FIG. 1.

In step S310, the receiving unit 110 receives a first user information. More specifically, the user login screen may be displayed by the display device (e.g., the television) connected to the electronic device 100 through the network or other methods, so that the receiving unit 110 may receive the input operation of the user to be recorded as the first user information. The first user information may be presented in a manner of images and/or text, but a method for presenting the user information is not particularly limited in the invention.

It is noted that, in an embodiment, the electronic device 100 may include a user database 130 stored in a storage unit of the electronic device 100 and used to record a plurality of user information. Herein, the storage unit may be a fixed or a movable device in any possible forms including a random access memory (RAM), a read-only memory (ROM), a flash memory or other similar devices, or a combination of the above-mentioned devices. The receiving unit 110 is connected with the user database 130 for displaying the user information recorded in the user database 130 through the display device, so as to provide the user for selecting the account that belongs to the user. The user information may be manually entered and stored in the user database 130 when the electronic device 100 is operated for the first time, or the user information may also be obtained from a social network through the network and directly imported to the user database 130.

In another embodiment, the user information may also be recorded in a user database on a cloud server, so that the receiving unit 110 may access the user information in the user database through the network. In the present embodiment of the invention, the network may be realized by a wired connection such as asymmetric digital subscriber line (ADSL) and cable modem, or a wireless connection such as wireless fidelity (WiFi) and mobile communication system, but the invention is not limited thereto. The cloud server may be one or more personal computers, working stations, host computers, or other computers or processors in various types. Methods of providing and recording the user information are not particularly limited in the invention.

In step S320, the processing unit 120 obtains a login authentication message corresponding to the first user information according to the first user information. More specifically, the processing unit 120 may obtain the corresponding login authentication message according to whether the identity authentication of the first user information is completed (i.e., whether a login authentication process thereof is completed).

Herein, the login authentication message is further described as below. In the present embodiment, the login authentication message may be used to determine whether the user is ever used to successfully log in the system. When the system is successfully logged in by the user after entering the account and the password, the user information may be used to obtain the login authentication message indicating that the identity authentication is completed. The login authentication message may also be used as the account and the password of the user for transmission and communication of data in the system. Therein, the login authentication message may be set to be valid within a period of time, and the user may transmit data that originally requires the identity authentication in the system directly through the login authentication message when the login authentication message is still valid without entering the account and the password again. In an embodiment, whether the login authentication message is valid may be set by presetting a valid time. For instance, the valid time may be set to three months. In another embodiment, whether the login authentication message is valid may also be set by setting the login authentication message to automatically become invalid when a number of login times is greater than a threshold value, and a setting method for determining whether the login authentication message is valid is not limited by the invention. In the present embodiment, the login authentication message may be realized by using a technique of session token, but the invention is not limited thereto.

Hereinafter, referring back to step S320 of the present embodiment. In other words, in an embodiment, when the identity authentication of the first user information is already completed, the processing unit 120 may directly obtain the login authentication message corresponding to the first user information. In another embodiment, the identity authentication of the first user information is not yet completed, so that the processing unit 120 may provide the login authentication message corresponding to the first user information after the authentication of the first user information is executed.

In step S330, the receiving unit 110 receives a current sequence combination corresponding to a plurality of physical function buttons being pressed. In step S340, the processing unit 120 compares the current sequence combination with a preset sequence combination of function buttons in the login authentication message. In step S350, the processing unit 120 determines whether a login process of the first user information is completed. More specifically, the sequence combination of function buttons may be corresponding to the passcode for logging in the system, so that the user may directly complete the identity authentication by pressing the function buttons, thereby providing the login method which is more convenient for the user to obtain permissions of the system. In an embodiment, after the processing unit 120 confirms that the identity authentication is completed by the user and the corresponding login authentication message is obtained, the receiving unit 110 may allow the user to set the preset sequence combination of function buttons through a system interface displayed on the display device. As a result, when next time the user intends to log in, the user may directly press the function buttons to enter the passcode corresponding to the sequence combination of function buttons. When the processing unit 120 compares the entered current sequence combination with the preset sequence combination of function buttons in the login authentication message, and determines that a result of above determination is that they are identical, the processing unit 120 may then determine that the login process of the first user information is completed, so that the identity authentication of the first user information may be quickly completed for allowing the user to log in the system.

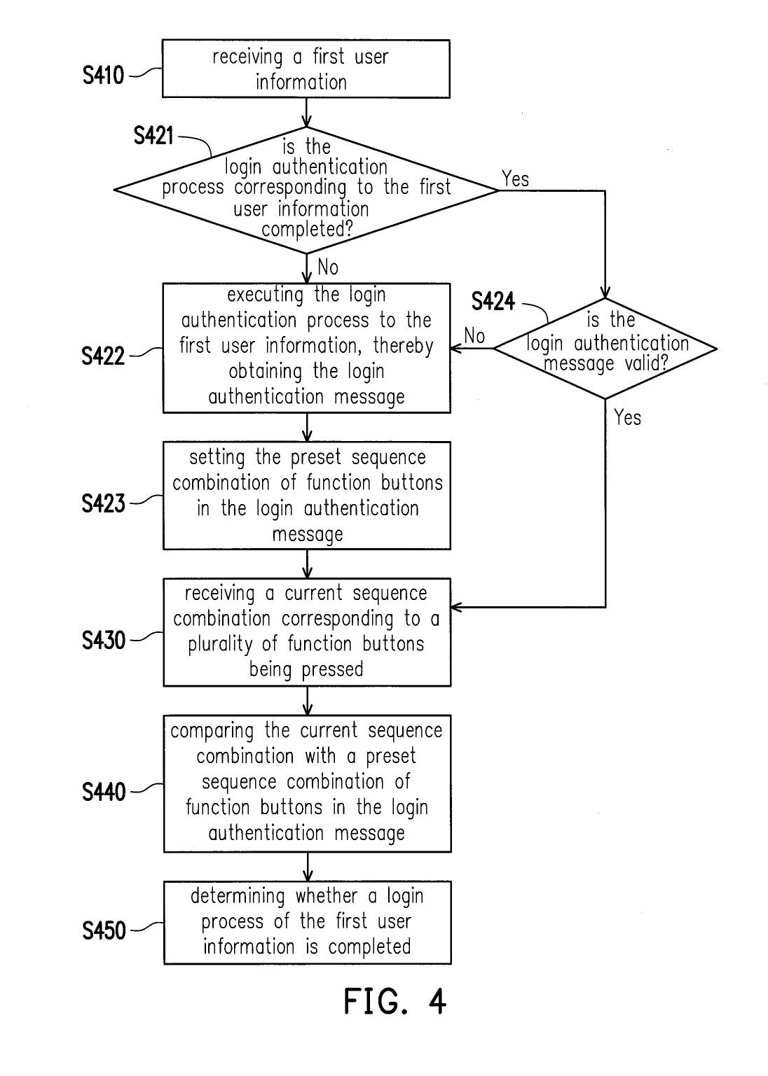

Another embodiment is provided below and served to describe the login method proposed in the embodiments of the invention, so that personal skilled in the art may further understand the implementations for the embodiments of the invention more clearly. Referring to FIG. 4, FIG. 4 is a flowchart illustrating a login method according to an embodiment of the invention. A method of the present embodiment is suitable for the electronic device 100 depicted in FIG. 1, in which the present embodiment is similar to the foregoing embodiment, thus identical or similar description may refer to the same in the foregoing embodiment. In the present embodiment, the login authentication message may be realized by a session token. Therein, the account and the password of the user are stored in the session token, the preset sequence combination of function buttons corresponding to the physical function buttons is also recorded in the session token in the present embodiment and served as the passcode for logging in a Network Attached Storage (NAS) system of the electronic device, so as to accomplish an effect of simplifying the login process. The implementation of the present embodiment is described in detail as follows.

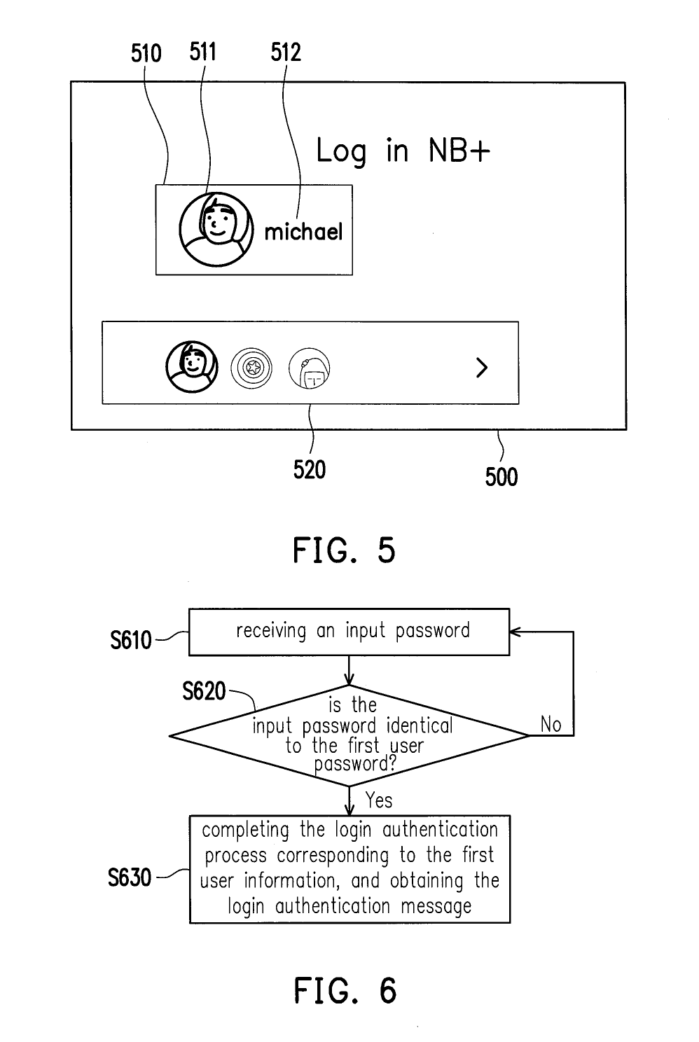

In step S410, the receiving unit 110 receives the first user information, in which the input operation of the user is received through a login interface displayed by the display device to be recorded as the first user information. For instance, FIG. 5 is an example illustrating a login method according to an embodiment of the invention, in which a login interface 500 displayed by the electronic device 100 through the display device is illustrated. In the present embodiment, the login interface 500 is provided for the user to log in the system named “NB+”, as shown in FIG. 5. The receiving unit 110 may list a menu 520 containing a plurality of user information by utilizing an image 511 and/or a text 512, and provide the user for selecting the user information from said menu by utilizing the electronic device 100 or the direction button (or other control function buttons capable of making selections) on the remote control device (e.g., the remote controller) capable of controlling the electronic device 100, so that a user information 510 being selected may be enlarged and displayed in the middle of the login interface 510. The receiving unit 110 may receive the input of the user to be used as the first user information.

In step S421, the processing unit 120 determines whether the login authentication process corresponding to the first user information is completed. More specifically, in an embodiment, the processing unit 120 may determine whether the login authentication process is completed according to a previous login time recorded in the first user information. In case the previous login time is not recorded in the first user information, it indicates that the user is logging in the system for the first time and the login authentication is not yet completed, so that the step of obtaining the corresponding login authentication message and subsequent steps need to be performed. In other embodiments, according to the number of login times recorded in the first user information, whether the first user information is included with the corresponding login authentication message, or other information regarding login records, which are recorded in the first user information, the processing unit may also determine whether the login authentication process is completed as well as whether the corresponding login authentication message is obtained.

Both cases of the login authentication process of the first user information not being completed and said login authentication process being completed, are respectively described as follows. First of all, the case of the login authentication process of the first user information not being completed is described. It should be noted that, in this case, since the login authentication process of the first user information is not completed, the login authentication message corresponding to the first user information is not yet obtained, and the preset sequence combination of function buttons corresponding to the login authentication message and being used for the login authentication is not set either. In other words, in the present embodiment, the processing unit 120 may process the login authentication message and the preset sequence combination of function buttons.

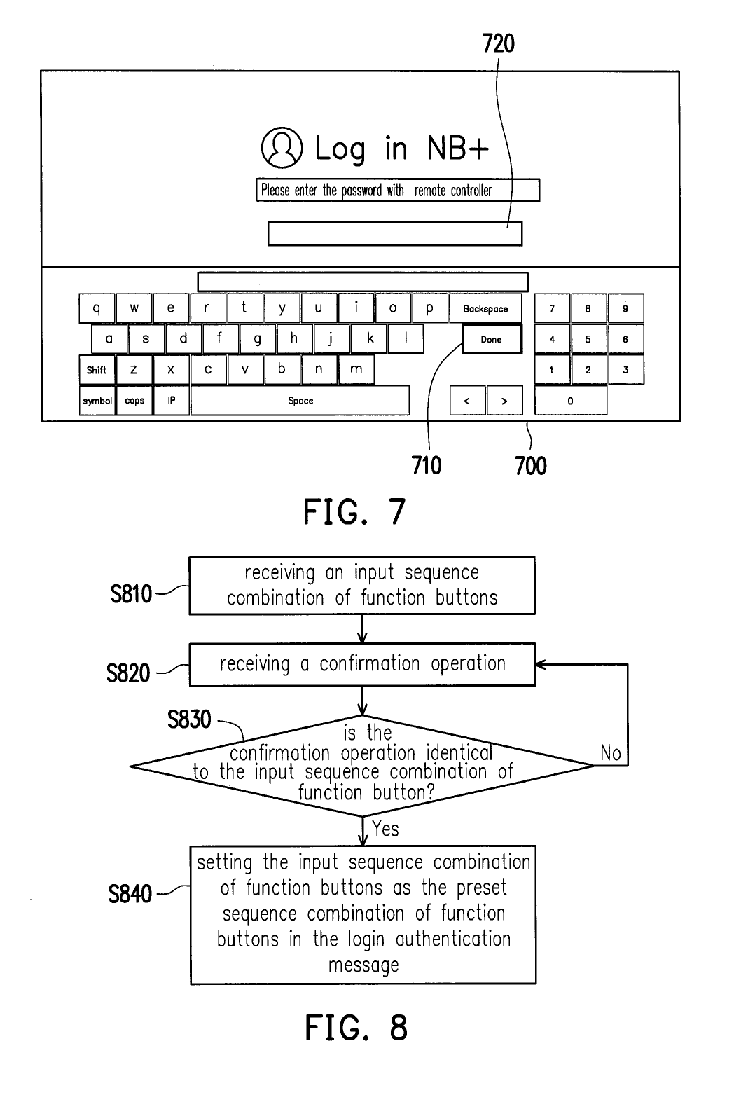

In step S422, the processing unit 120 may execute the login authentication process to the first user information, thereby obtaining the login authentication message corresponding to the first user information. More specifically, detailed steps for the login authentication process may refer to the embodiment of FIG. 6. FIG. 6 is a flowchart illustrating a login authentication process according to an embodiment of the invention, and the present embodiment is suitable for the electronic device 100 depicted in FIG. 1. When the first user information is obtained, in step S610, the receiving unit 110 receives an input password entered by the user. In the present embodiment, the electronic device 100 may display a login screen and a screen keyboard through the display device, so that the user may utilize the direction button on the remote control device to select the characters to be entered from the screen keyboard and served as the input password. For instance, an example of FIG. 7 illustrates a login interface 700 displayed by the electronic device 100 through the display device, and the login interface 700 is used for providing the user to log in the “NB+” system. In the present embodiment, the user may control and move a selecting frame 710 in FIG. 7 through the direction button 210 on the remote control device in the embodiment of FIG. 2, so as to select the corresponding characters from the screen keyboard for entering the password. In another embodiment, the user may also utilize the direction button provided by the electronic device 100 to select the characters for entering. Or, in other embodiments, the screen keyboard may also be displayed on the display device in other manners (e.g., a menu or a scroll) for the user to select through the direction button for entering the input password. Person skilled in the art may provide different methods for the user to enter the input password based on the actual demands, and the invention is not limited thereto. In addition, a field 720 in the login interface 700 is used to display an input content corresponding to the function buttons pressed by the user.

Referring back to FIG. 6, in step S620, the processing unit 120 compares the input password with a first user password corresponding the first user information, thereby determining whether the input password is identical to the first user password. More specifically, the processing unit 120 may search the user database recording the user information, and obtain the first user password corresponding the first user information from therein. The user database may be located in the electronic device 100, or may be located in the cloud server connected to the electronic device through the network, as described in the foregoing embodiment.

When the processing unit 120 determines that the input password is identical to the first user password, it indicates that the password entered by the user is correct and the system may be successfully logged in. In step S630, the processing unit 120 completes the login authentication process corresponding to the first user information, and obtains the login authentication message. Therein, the login authentication message includes the first user information and the corresponding first user password, and indicates that the login authentication message of the first user information is completed. Therefore, by going through the processes in the embodiment of FIG. 6, the processing unit 120 may complete the login authentication process, thereby obtaining the login authentication message corresponding to the first user information.

Referring back to processes of FIG. 4, after the login authentication process of the first user information is completed and the login authentication message is obtained by processing unit 120, in step S423, the processing unit 120 may set the preset sequence combination of function buttons in the login authentication message. Thereafter, the user may directly complete the login authentication for the system by entering the preset sequence combination of function buttons as the passcode for logging in the system, so as to simplify the operation for entering the password and quickly complete the identity authentication. Next, an embodiment of FIG. 8 is further provided to describe an implementation for the processing unit 120 to set the preset sequence combination of function buttons in the login authentication message.

Referring to FIG. 8, FIG. 8 is a flowchart illustrating setting of the preset sequence combination of function buttons according to an embodiment of the invention, and the present embodiment is suitable for the electronic device 100 depicted in FIG. 1. In step S810, the receiving unit 110 receives an input sequence combination of function buttons. The input sequence combination of function buttons may be entered by the user utilizing the function buttons on the remote control device as described in the embodiment of FIG. 2. In other embodiments, the corresponding input sequence combination of function buttons may also be obtained through the physical function buttons provided by the electronic device 100, and the invention is not limited thereto.

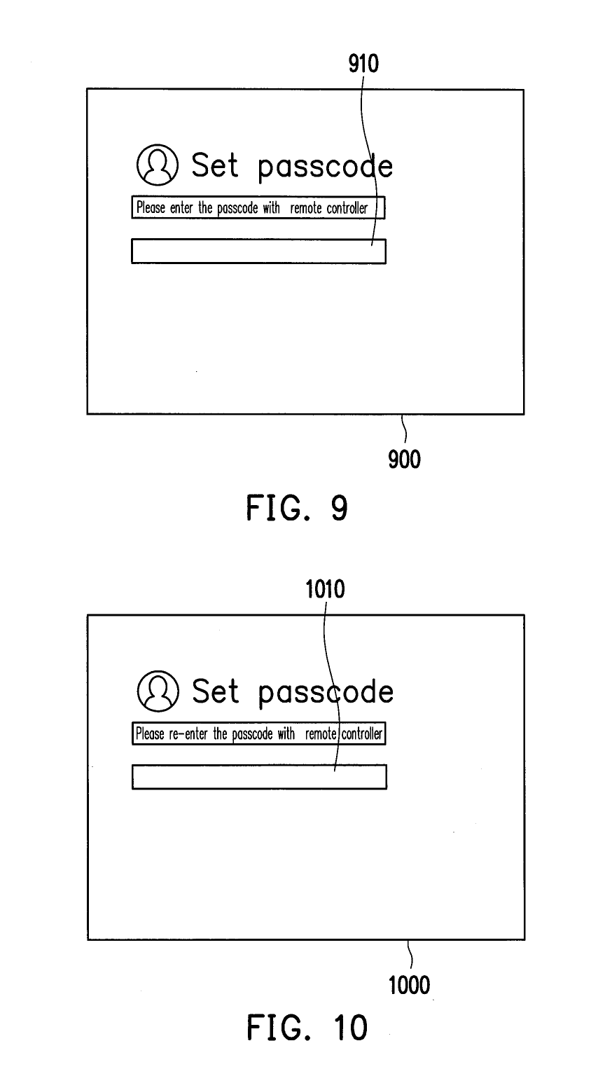

More specifically, referring to an example of FIG. 9. In FIG. 9, a login interface 900 is illustrated according to an embodiment of the invention. After the login authentication is completed by the user and the corresponding login authentication message is obtained in above-said step, the electronic device 100 may provide the login interface 900 as depicted in FIG. 9 to be displayed on the display device, so as to provide the user for setting the preset sequence combination of function buttons. The user may follow instructions on the login interface to press a plurality of function buttons on the remote control device in the embodiment of FIG. 2, and set the sequence combination of function buttons being pressed as the passcode composed of the function buttons. The passcode may be displayed in a field 910 of the login interface 900 by utilizing images corresponding to the function buttons, or may be simply displayed in symbols representing an amount of time for pressing the function buttons which indicates that signals sent by the function buttons being pressed are received. The processing unit 120 may record the sequence combination of function buttons being pressed in a register.

Referring back to the processes of FIG. 8, after the sequence combination of function buttons is received by the receiving unit 110, in step S820, the receiving unit 110 receives a confirmation operation for the processing unit 120 to determine whether the confirmation is identical to the input sequence combination of function buttons. More specifically, the confirmation operation may be a sequence combination of function buttons being pressed again and entered by the user. After the confirmation operation is received by the receiving unit 110, the processing unit 120 may compare the input sequence combination of function buttons obtained in step S810 with the confirmation operation, so as to determine whether the two are identical. In the present embodiment, the receiving unit 110 may also utilize the login screen displayed by the display device as described above to receive the confirmation operation of the user.

For instance, referring to an example of FIG. 10. An example of FIG. 10 illustrates a login interface 1000 displayed by the electronic device 100 through the display device. In the present embodiment, the receiving unit 110 may utilize the login interface 1000 to request the user for entering the confirmation operation corresponding to the preset sequence combination of function buttons. With various physical function buttons on the remote control device as depicted in the embodiment of FIG. 2, the user may directly press said physical function buttons to re-enter the confirmation operation and display the confirmation operation in a field 1010.

Referring back to the processes of FIG. 8, in steps S830 and S840, when the processing unit 120 determines that the confirmation operation is identical to the input sequence combination of function button, the processing unit 120 may set and record the input sequence combination of function buttons as the preset sequence combination of function buttons in the login authentication message. In other words, the processing unit 20 may perform a confirmation to the preset sequence combination of function buttons set by the user through the confirmation operation. The preset sequence combination of function buttons may be a specific time for holding the physical function button or a number of times for pressing the physical function button (e.g., holding the mute button for exceeding 5 seconds or pressing the mute button for four times within 10 seconds), so as to avoid a setting error caused by the user when other function buttons are mistakenly pressed by the user.

In other embodiments, the confirmation operation may also be realized by using other methods. For instance, the processing unit 120 may also display the input sequenced combination of function buttons in images through the display device, so that the user may view the images being displayed for the confirmation. After a signal of the confirm button being pressed by the user is received by the receiving unit 110, the processing unit 120 may record the input sequence combination of function buttons as the preset sequence combination of function buttons in the login authentication message corresponding to the first user information. For implementation of the confirmation operation in the present embodiment, it falls in the scope of the present invention for which protection is sought as long as the user is capable of confirming whether the input sequence combination of function buttons is correct.

It should be noted that, in some embodiments, steps S820 and S830 in FIG. 8 may be omitted. Namely, the confirmation of the preset sequence combination of function buttons may not be performed. Instead, the input sequence combination of function buttons entered by the user may be directly used as the preset sequence combination of function buttons and recorded in the login authentication message corresponding to the first user information.

Further, in some embodiment, when the preset sequence combination of function buttons is to be set, the user may also set the preset sequence combination of function buttons directly through an input/output device (e.g., a mouse or a keyboard connected through USB, bluetooth or wireless transmission), and log in the system through signals triggered by the input/output device when the identity authentication is required.

Therefore, the electronic device 100 may complete setting of the preset sequence combination of function buttons according to the processes illustrated in FIG. 8. In this way, the login authentication of the first user information is completed, the login authentication message is obtained, and the preset sequence combination of function buttons thereof is also set and bundled together with the login authentication message to be recorded in the login authentication message. As a result, when the user intends to log in the system later on, the function buttons may be directly pressed to enter the passcode corresponding to the sequence combination of function buttons thereby quickly complete the identity authentication of the system with the login authentication message, so as to simplify the process of logging in the system. Referring back to FIG. 4, detailed processes for the user to log in the system through the passcode of the input sequence combination of function buttons are described as follows.

Referring to FIG. 4, in step S430, the receiving unit 110 receives a current sequence combination corresponding to a plurality of function buttons being pressed. As similar to that in the foregoing embodiment, with the register, the processing unit 120 of the present embodiment may also record the current sequence combination entered by the user pressing the function buttons in the register. In step S440, the processing unit 120 compares the current sequence combination with a preset sequence combination of function buttons in the login authentication message. In step S450, the processing unit 120 determines whether a login process of the first user information is completed. An embodiment is given for illustration below.

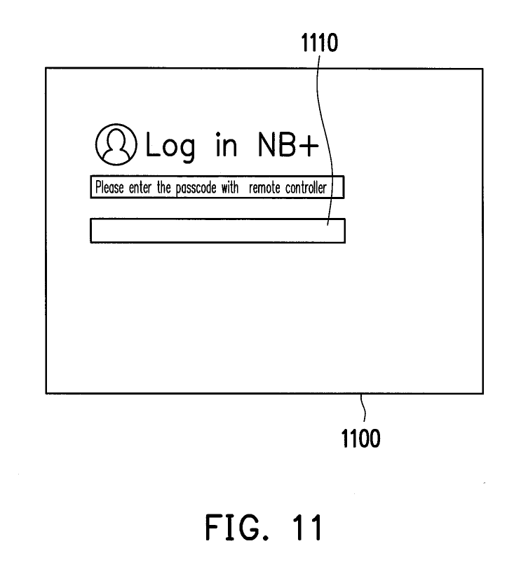

Referring FIG. 11, FIG. 11 is an example illustrating a login method according to an embodiment of the invention, in which a login interface 1100 displayed by electronic device 100 through the display device is illustrated and configured for the user to log in the “NB+” system. In the present embodiment, the login authentication of the first user information is already completed, the login authentication message is obtained, and the preset sequence combination of function buttons thereof is also set. In this case, when a corresponding user account is selected by the user and the first user information corresponding to the user is received by the receiving unit 110, the processing unit 120 may display the login interface 1100 as depicted in FIG. 11 through the display device connected to the electronic device 100. In view of the login interface 1100, it can be known that the user may enter the passcode by utilizing the sequence combination of function buttons being pressed through the remote control device of FIG. 2 for logging in the system. The current sequence combination entered by the user may be displayed in a field 1110, and when the processing unit 120 determines that the current sequence combination entered by the user is identical to the preset sequence combination of function buttons already set in the login authentication message, the user may quickly complete the identity authentication for login. Accordingly, the user may enter the passcode through the sequence combination of function button being pressed, and directly complete the login authentication without entering the password for logging in the system by using the direction button for multiple times to move the selecting frame of the screen keyboard frame by frame. As a result, a complexity of the login process is significantly lowered.

Furthermore, in some embodiments, in case the first user information is used to log in the system for the first time, steps S430 to S450 in FIG. 4 may be omitted. In other words, after step S423 is executed by the electronic device 100 of the present embodiment, the identity authentication of the first user information is substantially completed, and the system is successfully logged in. Therefore, it is not required for the user to enter the sequence combination of function buttons for the identity authentication again (i.e., corresponding to steps S430 to S450), and transmission and communication of data in the system may be performed by directly using the login authentication message that is already obtained.

The implementation of how the first user information completes the login authentication and sets the sequence combination of function buttons for the identity authentication when the login authentication process of the first user information is not yet completed is as described above. Subsequently, referring back to step S421 of FIG. 4, in some embodiments, if the processing unit 120 determines that the login authentication process of the first user information is already completed, proceeding to step S424 in which detailed implementation thereof is provided as follows.

When the login authentication process of the first user information is completed, it means that the first user information at the time is already corresponding to one login authentication message. Accordingly, in step S424, the processing unit 120 may determine whether the login authentication message is valid according to a login time information of the first user information and the valid time corresponding to the login authentication message, thereby obtaining the login authentication message corresponding to the first user information.

More specifically, in an embodiment, the first user information may record the previous login time of the first user information through the login time information, and compare a login time interval between the previous login time and the current login time with the valid time. For instance, in the present embodiment, the valid time of the login authentication message may be three months. Therefore, when the login time interval of the first user information exceeds three months, the login authentication message of the first user information is substantially deemed as invalid. In other words, in case the login time interval exceeds the valid time, despite that the first user information has been successfully logged in the system before, the identity authentication needs to be performed again, so as to obtain a new login authentication message and re-set the preset sequence combination of function buttons thereof (i.e., corresponding to steps S422 to S423). A method used herein is similar to that in the foregoing embodiments, thus related description may refer to the foregoing embodiments.

On the other hand, in case the login time interval of the first user information is within the valid time, it indicates that the login authentication of the first user information is completed, and the preset sequence combination of function buttons in the login authentication message is also set. Therefore, in an embodiment, when the processing unit 120 determines that the login time interval of the first user information is within the valid time, the electronic device 100 may provide the login interface 1100 as depicted in FIG. 11 for the user to enter the passcode for logging in the system directly through the sequence combination of the function buttons, so as to quickly complete the identity authentication for logging in the system.

Accordingly, by determining whether the login authentication message of the first user information is valid, whether the identity authentication of the first user information is completed may be ensured, and a permission for logging the system may be obtained through the preset sequence combination of function buttons already set.

It should be note that, in an embodiment, each of the user information provided by the electronic device 100 may also be corresponding to permissions of different systems. For instance, the user information may also include a first, a second and a third users. Therein, the first user information may corresponding to a device administrator which has access to all data in the electronic device 100. In other words, the first user of the present embodiment has a highest permission with respect to the electronic device 100. The second user may corresponding to parents in a family group, and has a permission to access the image content of a martial arts type. The third user may corresponding to children in the family group, and only has a permission to access the image content of an animation type. As a result, the login method according to the embodiments of the invention may also be applied for identity authentications of different users, so that each user may access the corresponding type of data directly through their corresponding permission after logged in the system.

Further, in an embodiment, the first user information may corresponding to the device administrator who may decide whether other users are allowed to share data recorded in the electronic device 100. In the present embodiment, the device administrator may select user accounts to be invited from a plurality of user information recorded in the cloud database. The selected user accounts may be displayed on the login screen (e.g., the login interface 500 of FIG. 5) displayed by the display device, and a login permission of the electronic device 100 may then be obtained. Accordingly, the login method according to the embodiments of the invention may accomplish a more diversified and wider application through setting different permissions for different users.

In summary, when the identity authentication of the user is performed, the electronic device and the login method thereof according to the embodiments of the invention are capable of obtaining the login authentication message corresponding to the user and the sequence combination of function buttons thereof to be used as the passcode for authentication of the user to facilitate in login. Moreover, according to the embodiments of the invention, mechanisms including determining whether the login authentication message is valid, and whether the sequence combination of function buttons is corrected are also provided. Accordingly, the difficulties in entering the password may be solved by the function buttons on the remote controller, and the identity authentication may be simplified and quickly completed, so as to provide a better user experience for the user. Furthermore, the login method according to the embodiments of the invention may accomplish a more diversified and wider application through setting different permissions for different users.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A login method of an electronic device, comprising:
receiving a first user information;
obtaining a login authentication message corresponding to the first user information according to the first user information;
receiving a current sequence combination corresponding to a plurality of function buttons being pressed, wherein the function buttons are used for controlling the electronic device to execute a plurality of functions correspondingly;
comparing the current sequence combination with a preset sequence combination of the function buttons in the login authentication message; and
determining whether a login process of the first user information is completed.

2. The login method of claim 1, wherein the step of obtaining the login authentication message corresponding to the first user information according to the first user information comprises:
determining whether a login authentication process corresponding to the first user information is completed according to the first user information, thereby obtaining the login authentication message corresponding to the first user information.

3. The login method of claim 2, wherein the login authentication message is corresponding to a valid time, and the step of determining whether the login authentication process corresponding to the first user information is completed according to the first user information, thereby obtaining the login authentication message corresponding to the first user information comprises:
executing the login authentication process for the first user information when the login authentication process corresponding to the first user information is not completed, thereby obtaining the login authentication message corresponding to the first user information; and
determining whether the login authentication message is valid according to a login time information of the first user information and the valid time when the login authentication process corresponding to the first user information is completed, thereby obtaining the login authentication message corresponding to the first user information.

4. The login method of claim 3, wherein the step of executing the login authentication process for the first user information when the login authentication process corresponding to the first user information is not completed, thereby obtaining the login authentication message corresponding to the first user information comprises:
receiving an input password;
comparing the input password with a first user password corresponding the first user information, thereby determining whether the input password is identical to the first user password; and
completing the login authentication process corresponding to the first user information and obtaining the login authentication message when the input password is identical to the first user password.

5. The login method of claim 4, wherein the function buttons are physical function buttons,
and after the step of obtaining the login authentication message, the login method comprises:
setting the preset sequence combination of the physical function buttons in the login authentication message.

6. The login method of claim 5, wherein the step of setting the preset sequence combination of the function buttons in the login authentication message comprises:
receiving an input sequence combination of the function buttons;
receiving a confirmation operation for determining whether the confirmation operation is identical to the input sequence combination of the function buttons; and
setting the input sequence combination of the function buttons as the preset sequence combination of the function buttons in the login authentication message when the confirmation operation is identical to the input sequence combination of the function buttons.

7. The login method of claim 3, wherein the step of determining whether the login authentication message is valid when the login authentication process corresponding to the first user information is completed comprises:
re-executing the login authentication process for the first user information when the login authentication message is invalid, thereby obtaining the login authentication message and setting the preset sequence combination of the function buttons.

8. An electronic device, comprising:
a receiving unit receiving a first user information and a current sequence combination corresponding to a plurality of function buttons being pressed, wherein the function buttons are used for controlling the electronic device to execute a plurality of functions correspondingly; and
a processing unit coupled to the receiving unit, wherein the processing unit obtains a login authentication message corresponding to the first user information according to the first user information, and compares the current sequence combination with a preset sequence combination of the function buttons in the login authentication message, thereby determining whether a login process of the first user information is completed.

9. The electronic device of claim 8, wherein the processing unit determines whether a login authentication process corresponding to the first user information is completed according to the first user information, thereby obtaining the login authentication message corresponding to the first user information.

10. The electronic device of claim 9, wherein the login authentication message is corresponding to a valid time, the processing unit executes the login authentication process for the first user information when the login authentication process corresponding to the first user information is not completed, thereby obtaining the login authentication message corresponding to the first user information, and the processing unit determines whether the login authentication message is valid according to a login time information of the first user information and the valid time when the login authentication process corresponding to the first user information is completed, thereby obtaining the login authentication message corresponding to the first user information.

11. The electronic device of claim 10, wherein when the login authentication process corresponding to the first user information is not completed, the receiving unit receives an input password, the processing unit compares the input password with a first user password corresponding the first user information, thereby determining whether the input password is identical to the first user password, and the processing unit completes the login authentication process corresponding to the first user information and obtains the login authentication message when the input password is identical to the first user password.

12. The electronic device of claim 11, wherein after the login authentication message is obtained, the processing unit sets the preset sequence combination of the function buttons in the login authentication message.

13. The electronic device of claim 12, wherein the receiving unit receives an input sequence combination of the function buttons and a confirmation operation, the processing unit determines whether the confirmation operation is identical to the input sequence combination of the function buttons, and the processing unit sets the input sequence combination of the function buttons as the preset sequence combination of function buttons in the login authentication message when the confirmation operation is identical to the input sequence combination of the function buttons.

14. The electronic device of claim 10, wherein when the login authentication process corresponding to the first user information is completed, the electronic device re-executes the login authentication process for the first user information when the processing unit determines that the login authentication message is invalid, thereby obtaining the login authentication message and setting the preset sequence combination of the function buttons.

15. The electronic device of claim 8, wherein the electronic device comprises a display device, the function buttons are virtual function buttons displayed on the display device, and the receiving unit receives the current sequence combination corresponding to the function buttons being pressed through the virtual function buttons.

16. The electronic device of claim 15, wherein the virtual function buttons comprise at least one of a direction button, a volume control button, a channel selection button, a page selection button, a menu button and a mute button.

17. The electronic device of claim 16, wherein the receiving unit receives the current sequence combination corresponding to the virtual function buttons being pressed through a remote-control device having the virtual function buttons.

18. The electronic device of claim 16, wherein the function buttons comprise at least one of a physical direction button, a physical volume control button, a physical channel selection button, a physical page selection button, a physical menu button and a physical mute button.

19. The electronic device of claim 8, wherein the receiving unit receives the current sequence combination corresponding to the function buttons being pressed through a remote-control device having the function buttons.

20. The electronic device of claim 8, wherein the electronic device is further connected to a cloud server through a network, and the server comprises a user database that provides a plurality of user information to the receiving unit through the network.
